(19) United States
(12) Patent Application Publication
(10) Pub. No.: US 2025/0095628 A1
(43) Pub. Date: Mar. 20, 2025

(54) NOISE CONTROL APPARATUS, NOISE CONTROLMETHOD, AND PROGRAM

(71) Applicant: NIPPON TELEGRAPH AND TELEPHONE CORPORATION, Tokyo (JP)

(72) Inventors: Yohei WAKISAKA, Tokyo (JP); Noriyoshi KAMADO, Tokyo (JP); Hiroaki ITO, Tokyo (JP); Shin MURATA, Tokyo (JP)

(73) Assignee: NIPPON TELEGRAPH AND TELEPHONE CORPORATION, Tokyo (JP)

(21) Appl. No.: 18/728,857

(22) PCT Filed: Jan. 21, 2022
(86) PCT No.: PCT/JP2022/002205

§ 371 Date: Jul. 12, 2024

(51) Int. Cl. G10K 11/178

(52) U.S. Cl. CPC G10K 11/17823; G10K 11/17825; G10K 11/17881; G10K 2210/3026; G10K 2210/3027; G10K 2210/3028

(57) ABSTRACT

To provide a noise control apparatus capable of stabilizing a noise suppression operation even when noise characteristics rapidly change in a manner that the noise control apparatus is controlled by correcting a coefficient of an adaptive filter, stopping a cancelling speaker, and the like in accordance with the current position of a vehicle such as a train. The noise control apparatus generates a cancellation signal to be reproduced by a cancelling speaker by performing an operation corresponding to position information m of a moving object in which the cancelling speaker used in active noise control is installed.

### TECHNICAL FIELD

The present invention relates to an active noise control (ANC) technique for suppressing external noise at a specific position.

### BACKGROUND ART

Non Patent Literature 1 is known as a conventional active noise suppression technique. In active noise suppression, a reference microphone, an error microphone, and a cancelling speaker are generally used. FIG. 1 illustrates a configuration example of a conventional noise control apparatus. A reference microphone 91 collects noise generated by a noise source. A cancelling speaker 92 reproduces a cancellation signal generated by a suppression signal generation device 90, and emits a cancelling sound that cancels out the noise. Further, an error microphone 93 collects and feeds back uncanceled noise. The suppression signal generation device 90 actively controls and generates the cancellation signal by using a sound collection signal from the reference microphone 91 and a sound collection signal from the error microphone 93 so as to reduce the uncanceled noise. In order to emit a sound capable of appropriately suppressing noise from the cancelling speaker 92, the suppression signal generation device 90 generate the cancellation signal by applying an adaptive filter to the sound collected by the reference microphone 91.

### CITATION LIST

### Non Patent Literature

Non Patent Literature 1: KAJIKAWA, “active noise control no saikin wadai to ouyou (in Japanese)”, IPSJ special interest group on music and computer (MUS), vol. 2015-MUS-107, no. 3, pp. 1-6, May 2015.

### SUMMARY OF INVENTION

### Technical Problem

However, the adaptive filter has a problem: for example, in a case where a statistical property such as a sound volume or a deviation of a frequency component greatly changes with time, the process does not catch up with such a change, and a coefficient of an appropriate filter is not calculated, so that suppression performance becomes unstable. In particular, in a situation where noise is suppressed while moving in a train, the above problem becomes remarkable at a timing when an environment in which noise is generated greatly changes, such as an entrance and exit of a tunnel.

An object of the present invention is to provide a noise control apparatus, a noise control method, and a program capable of stabilizing a noise suppression operation even when noise characteristics rapidly change in a manner that the noise control apparatus is controlled by correcting a coefficient of an adaptive filter, stopping a cancelling speaker, and the like in accordance with the current position of a vehicle such as a train.

### Solution to Problem

In order to solve the above problem, according to an aspect of the present invention, a noise control apparatus generates a cancellation signal to be reproduced by a cancelling speaker by performing an operation corresponding to position information m of a moving object in which the cancelling speaker used in active noise control is installed.

### Advantageous Effects of Invention

According to the present invention, an effect that it is possible to stabilize a noise suppression operation even when noise characteristics change rapidly.

### BRIEF DESCRIPTION OF DRAWINGS

FIG. 1 is a diagram for explaining conventional active noise control.

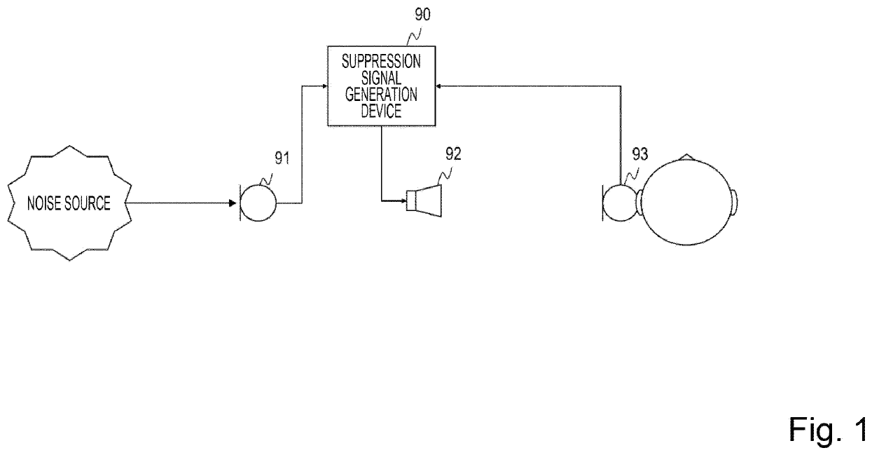

FIG. 2 is a functional block diagram of a noise suppress system according to a first embodiment.

FIG. 3 is a diagram illustrating an example of a processing flow of the noise suppress system according to the first embodiment.

FIG. 4 is a functional block diagram of a noise suppress system according to a second embodiment.

FIG. 5 is a diagram illustrating an example of a processing flow of the noise suppress system according to the second embodiment.

FIG. 6 is a diagram illustrating a configuration example of a computer to which the present method is applied.

### DESCRIPTION OF EMBODIMENTS

Hereinafter, embodiments of the present invention will be described. Note that, in the drawings to be used in the description below, components having the same functions or steps for performing the same processing will be labeled with the same reference signs, and description thereof will not be repeated.

### Points of First Embodiment

Position information and noise information are used in association with each other in order to use a relationship in which a specific noise environment is likely to be made at a specific position.
In a train or the like, characteristics that a traveling route is fixed, and reproducibility of a noise environment is high based on position information are used.

### First Embodiment

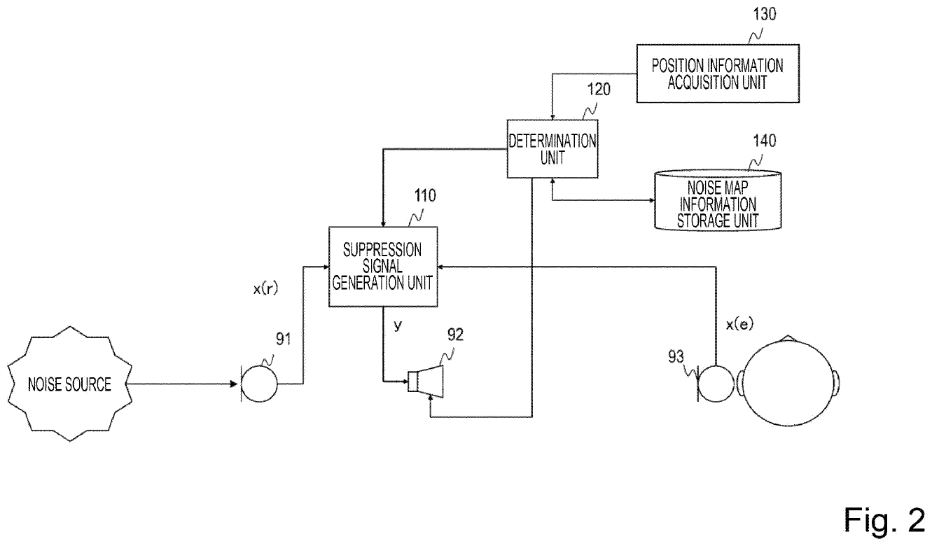

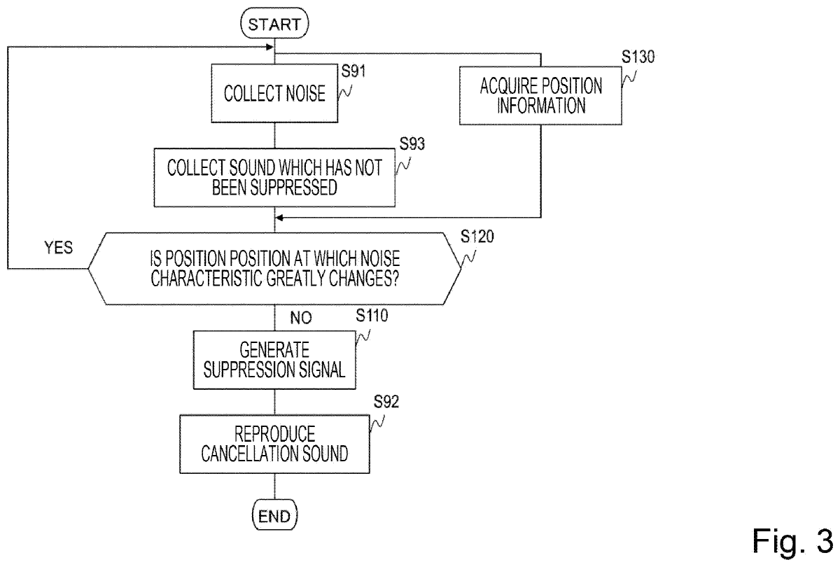

FIG. 2 is a functional block diagram of a noise suppress system according to a first embodiment. FIG. 3 illustrates a processing flow of the noise suppress system.

The noise suppress system includes a reference microphone 91, a cancelling speaker 92, an error microphone 93, a suppression signal generation unit 110, a determination unit 120, a position information acquisition unit 130, and a noise map information storage unit 140. A apparatus including the suppression signal generation unit 110, the determination unit 120, and the noise map information storage unit 140 is also referred to as a noise control apparatus.

The noise control apparatus generates a cancellation signal (referred to below as a “suppression signal”) y by receiving, as inputs, a sound collection signal x(r) of the reference microphone 91, a sound collection signal x(e) of the error microphone 93, and position information acquired by the position information acquisition unit 130, and performing an operation corresponding to position information of a moving object in which the reference microphone 91, the cancelling speaker 92, and the error microphone 93 are installed. Then, the noise control apparatus outputs the generated cancellation signal y to the cancelling speaker 92.

The noise control apparatus is a special device configured such that a special program is loaded into a known or dedicated computer including, for example, a central processing unit (CPU), a main storage device (random access memory (RAM)), and the like. The noise control apparatus executes each of pieces of processing under control of the central processing unit, for example. Data input into the noise control apparatus and data obtained in each of the pieces of processing are stored in, for example, the main storage device, and the data stored in the main storage device is read to the central processing unit as necessary and used for other type of processing. At least some of the processing units of the noise control apparatus may be configured by hardware such as an integrated circuit. Each of the storage units included in the noise control apparatus can be configured by, for example, a main storage device such as a random access memory (RAM) or middleware such as a relational database and a key value store. Note, however, that each of the storage units is not necessarily provided inside the noise control apparatus. Each of the storage units may be configured by an auxiliary storage device including a hard disk, an optical disk, or a semiconductor memory device such as a flash memory, and may be provided outside the noise control apparatus.

Each of the units will be described below.

### Reference Microphone 91

The reference microphone 91 collects a sound to be suppressed (S91) and outputs a sound collection signal x(r). The sound as a suppression target, which is collected by the reference microphone 91, is referred to below as “noise”.

### Error Microphone 93

The error microphone 93 collects a sound that includes uncanceled noise and has not been suppressed with the reproduced sound reproduced from the cancelling speaker 92 (S93), and then outputs a sound collection signal x(e).

### Position Information Acquisition Unit 130

The position information acquisition unit 130 acquires position information m of a moving object in which the reference microphone 91, the cancelling speaker 92, and the error microphone 93 included in the noise suppress system are installed (S130), and then outputs the position information m. For example, the position information acquisition unit 130 includes a global positioning system (GPS) or the like, and is installed in a moving object in which the reference microphone 91, the cancelling speaker 92, and the error microphone 93 are installed.

### Determination Unit 120 and Noise Map Information Storage Unit 140

The noise map information storage unit 140 stores noise map information corresponding to position information. The noise map information is noise information associated with the position information, and is information indicating whether or not the position is a position at which the noise characteristic greatly changes. Note that the noise characteristic is a characteristic indicating the deviation or magnitude of a frequency band of a sound including noise, and may be referred to as a statistical characteristic of noise. For example, as the noise map information, the noise map information storage unit 140 may store a position (for example, coordinates) at which the noise characteristic greatly changes or a range of the position, a position (for example, coordinates) at which the noise characteristic does not greatly change or a range of the position, or information indicating whether or not the position is a position at which the noise characteristic greatly changes for each position (for example, each coordinate). For example, in a case where the reference microphone 91, the cancelling speaker 92, and the error microphone 93 are installed in a vehicle such as a train or an automobile, the noise characteristic greatly changes at an entrance, an exit, or the like of a tunnel. Thus, the noise map information corresponding to the position information of the entrance or exit of the tunnel indicates a position at which the noise characteristic greatly changes.

With reference to the noise map information storage unit 140, the determination unit 120 determines whether or not the position of the position information m is a position at which the noise characteristic greatly changes by receiving the position information m as an input (S120).

In a case where the position is a position at which the noise characteristic greatly changes (YES in S120), the determination unit 120 outputs a control signal indicating that an ANC operation is not performed. Since it is only necessary to perform control so as not to perform the ANC operation, the suppression signal generation unit 110, the cancelling speaker 92, and the like described later are considered as an output destination of the control signal. (i) The determination unit 120 may perform control so as not to perform the ANC operation by stopping reproduction of the cancellation signal y in the cancelling speaker 92. In this case, the reproduction of the cancellation signal y may be stopped by outputting the control signal to the cancelling speaker 92, or the generation or output of the cancellation signal y in the suppression signal generation unit 110 may be stopped by outputting the control signal to the suppression signal generation unit 110. (ii) The determination unit 120 may perform control so as not to perform the ANC operation by outputting the control signal to the suppression signal generation unit 110 and stopping the update of an adaptive filter. (i) to (ii) may be switched and controlled in accordance with the situation. However, by adopting (i) and maintaining the update of the adaptive filter, it is possible to prevent an occurrence of a situation in which the operation at the time of restarting the ANC operation becomes unstable. The time during which the ANC operation is not performed may be set to a time required until the operation of the ANC becomes stable.

In a case where the position is not a position at which the noise characteristic greatly changes (NO in S120), the determination unit 120 outputs a control signal indicating that the ANC operation is performed. However, when the control signal indicating that the ANC operation is not performed is not received in each unit, the determination unit 120 may be configured to basically perform the ANC operation. In addition, the determination unit 120 may be configured not to output the control signal indicating that the ANC operation is performed. In this case, in a case where the position is not a position at which the noise characteristic greatly changes (NO in S120), the determination unit 120 does not perform any processing, and causes the processing to transition to the suppression signal generation unit 110.

### Suppression Signal Generation Unit 110

The suppression signal generation unit 110 receives the sound collection signal x(r) and the sound collection signal x(e) as inputs, and generates the cancellation signal y for suppressing noise by using the sound collection signal x(r) and the model (S110). Then, the suppression signal generation unit 110 outputs the cancellation signal y. In addition, the suppression signal generation unit 110 updates the model by using the sound collection signals x(r) and x(e). For example, the model is an adaptive filter and updates filter coefficients of the adaptive filter.

As a method of generating the cancellation signal, a conventional technique can be used. For example, the method in Non Patent Literature 1 can be used. In the present embodiment, feedforward ANC is realized by the sound collection signal x(r), the sound collection signal x(e), and the cancellation signal y. An interference sound between noise from a noise source and the reproduced sound of the cancellation signal y is detected by the error microphone 93, the noise from the noise source is detected by the reference microphone 91, and the sound collection signal x(r) of the reference microphone 91 is input to the adaptive filter realized by a digital filter. In this manner, the cancellation signal y is generated and is reproduced by the cancelling speaker 92. The reproduced sound of the cancellation signal y propagates in a secondary route that is a series of transmission systems from the cancelling speaker 92 to the error microphone 93. By using the sound collection signal x(r) of the reference microphone 91 and the sound collection signal x(e) of the error microphone 93, the filter coefficient of the adaptive filter is updated by an adaptive algorithm such that the input of the error microphone 93 is minimized. Since a conventional update method can be used as a method of updating the filter coefficient of the adaptive filter, the description thereof will be omitted. In the feedforward ANC, a secondary route model in which the secondary route is estimated is used to compensate for an influence of the secondary route in the adaptive algorithm.

### Cancelling Speaker 92

The cancelling speaker 92 receives the cancellation signal y as an input, and reproduces the cancellation signal y (S92). In a case where the reproduced sound reproduced from the cancelling speaker 92 and the noise as the suppression target have completely opposite phases, if the reproduced sound overlaps the noise as the suppression target, that is, if the sound waves overlap each other, the waves cancel each other out, so that the noise is suppressed. Note that, as described above, the sound that has not been suppressed with the reproduced sound reproduced from the cancelling speaker 92 is collected by the error microphone 93.

### Effects

With the above configuration, it is possible to stabilize the noise suppression operation even when the noise characteristic changes rapidly.

In the conventional feedforward ANC, the coefficient of the adaptive filter is updated by using the sound collection signal x(r) of the reference microphone 91 and the sound collection signal x(e) of the error microphone 93. Therefore, the change in the noise characteristic can be detected only from the sound collection signal x(r) and the sound collection signal x(e) actually collected and obtained by the reference microphone 91 and the error microphone 93. Calculation of an appropriate filter coefficient may not catch up with a change in a noise characteristic, and noise suppression performance may be temporarily decreased or the ANC may not operate stably. For example, there is a probability that howling occurs, large noise is output because the ANC cannot catch up, or an excessive sound is output depending on the adaptive algorithm.

In the present embodiment, the change in a future noise characteristic is predicted by using the position information, and control is performed so as not to perform the ANC operation at a position at which the noise characteristic greatly changes, thereby preventing an unstable operation such as howling of the ANC.

The present embodiment is particularly effective because the determination accuracy in the determination unit 120 is increased when the present embodiment is applied to a case where the reference microphone 91, the cancelling speaker 92, and the error microphone 93 are installed in a vehicle such as a train whose travel route is determined.

### Second Embodiment

Differences from the first embodiment will be mainly described.

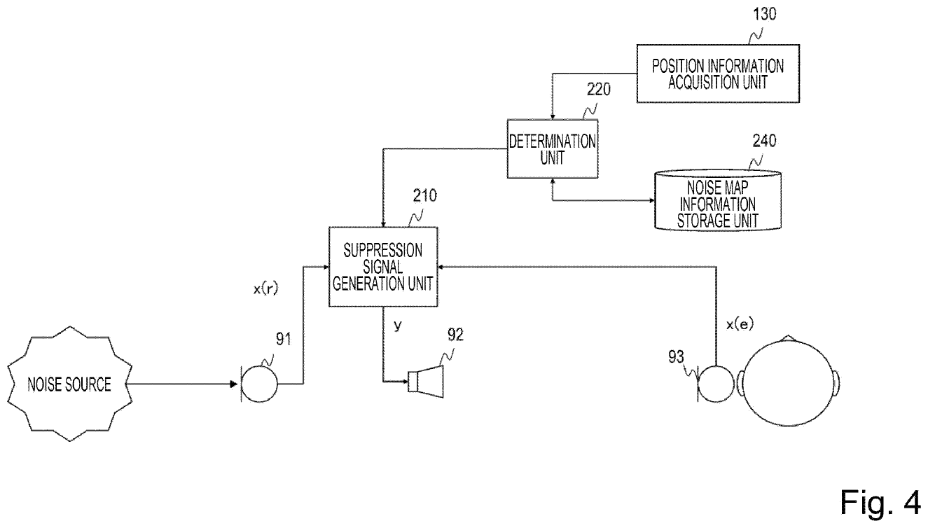

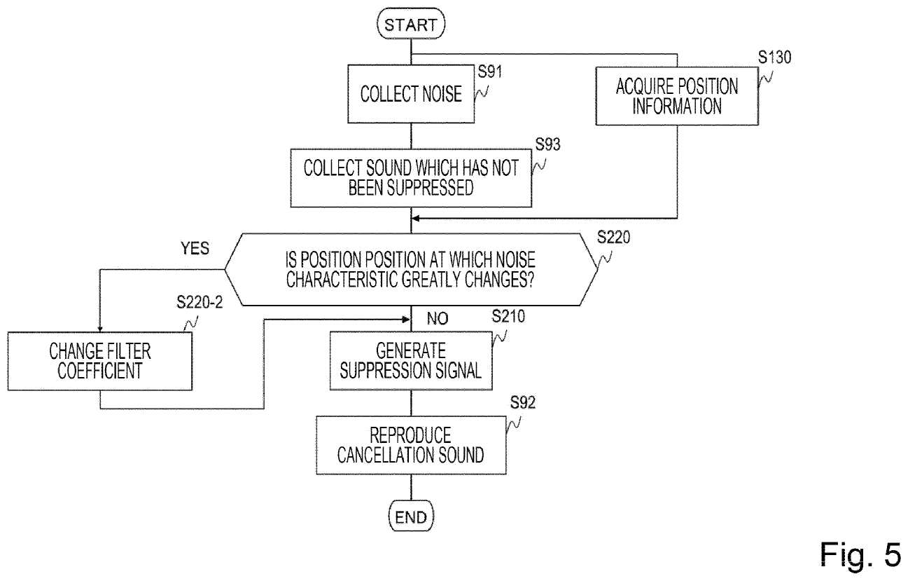

FIG. 4 is a functional block diagram of a noise suppress system according to a second embodiment. FIG. 5 illustrates a processing flow of the noise suppress system.

The noise suppress system includes a reference microphone 91, a cancelling speaker 92, an error microphone 93, a suppression signal generation unit 210, a determination unit 220, a position information acquisition unit 130, and a noise map information storage unit 240. A apparatus including the suppression signal generation unit 210, the determination unit 220, and the noise map information storage unit 240 is also referred to as a noise control apparatus.

### Determination Unit 220 and Noise Map Information Storage Unit 240

The noise map information storage unit 240 stores noise map information corresponding to position information. The noise map information in the present embodiment is noise information associated with position information, and is information indicating whether or not a position is a position at which a noise characteristic greatly changes and a model adapted to the changed noise characteristic at the position at which the noise characteristic greatly changes. The information indicating whether or not the position is a position at which the noise characteristic greatly changes is as described in the first embodiment. The model adapted to the changed noise characteristic is, for example, an adaptive filter, and the filter coefficient of the adaptive filter is stored in the noise map information storage unit 240. The model will be described below by using the adaptive filter and the filter coefficient thereof, but another model may be used. The filter coefficient may be obtained by calculating the filter coefficient of the adaptive filter adapted to the changed noise characteristic (for example, noise characteristics at the time of traveling in the tunnel), or may be the filter coefficient of the adaptive filter which has been obtained by the suppression signal generation unit 210 at the same position (for example, in the tunnel) in the past. For example, in a case where the reference microphone 91, the cancelling speaker 92, and the error microphone 93 are installed in a vehicle such as a train or an automobile, the noise characteristic greatly changes at the entrance of the tunnel. Thus, the noise map information corresponding to the position information of the entrance of the tunnel is the information indicating the position at which the noise characteristic greatly changes and the filter coefficient of the adaptive filter adapted to the noise characteristic at the time of traveling in the tunnel.

With reference to the noise map information storage unit 240, the determination unit 220 determines whether or not the position of the position information m is a position at which the noise characteristic greatly changes by receiving the position information m as an input (S220).

In a case where the noise characteristic greatly changes at the position (YES in S220), the determination unit 220 reads the filter coefficient of the adaptive filter that corresponds to the position information m and is adapted to the changed noise characteristic in advance, from the noise map information storage unit 240, and changes the filter coefficient of the adaptive filter of the suppression signal generation unit 210 to the read filter coefficient (S220-2).

In a case where the position is not a position at which the noise characteristic greatly changes (NO in S220), the determination unit 220 does not perform any processing, and causes the processing to transition to the suppression signal generation unit 210.

### Suppression Signal Generation Unit 210

The suppression signal generation unit 210 receives the sound collection signal x(r) and the sound collection signal x(e) as inputs, and generates the cancellation signal y for suppressing noise by using the sound collection signal x(r) and the model (S210). Then, the suppression signal generation unit 210 outputs the cancellation signal y. In addition, the suppression signal generation unit 110 updates the model by using the sound collection signal x(e). For example, the model is an adaptive filter and updates filter coefficients of the adaptive filter.

The method of generating the cancellation signal is similar to that of the first embodiment. However, the difference is that the filter coefficient of the adaptive filter is changed by the determination unit 220 in a case where the position is the position at which the noise characteristic greatly changes. Note that, after the change, the suppression signal generation unit 210 updates successive filter coefficients with the sound collection signal x(e) by the adaptive algorithm similarly to the conventional feedforward ANC.

### Effects

With such a configuration, it is possible to obtain the same advantageous effects as those of the first embodiment. Furthermore, it is possible to expect improvement in accuracy and speed of the cancellation signal in the suppression signal generation unit.

The present embodiment and the first embodiment may be combined. For example, the ANC operation is controlled not to be performed by the method in the first embodiment at a position at which it is not possible to prepare the model adapted to the changed noise characteristic, and the change to the model adapted to the changed noise characteristic by the method in the present embodiment is performed at a position at which the model adapted to the changed noise characteristic can be prepared.

### Modification Examples

In the present embodiment, the case where a vehicle enters into a tunnel from the outside of the tunnel has been described, but the noise characteristic greatly changes also in the case where the vehicle exits the tunnel from the inside of the tunnel. That is, at the position at which the noise characteristic greatly changes, a case where the noise characteristic changes from the noise characteristic A to the noise characteristic B and a case where the noise characteristic changes from the noise characteristic B to the noise characteristic A are considered. In a case where the reference microphone 91, the cancelling speaker 92, and the error microphone 93 are installed in a moving object in which a travel route of a railway or the like is determined in advance, how the noise characteristics change is determined in advance. Therefore, the present embodiment can be applied. In a case where the reference microphone 91, the cancelling speaker 92, and the error microphone 93 are installed in a moving object in which the travel route is not determined in advance, a model in a case where the noise characteristic changes from the noise characteristic A to the noise characteristic B and a model in a case where the noise characteristic changes from the noise characteristic B to the noise characteristic A may be prepared as the model adapted to the changed noise characteristic with respect to one piece of information indicating whether or not the noise characteristic greatly changes, and the prepared models may be stored in the noise map information storage unit 240. Note that, here, two models are used, but three or more models may be prepared in a case where the noise characteristic changes to three or more noise characteristics. In short, one or more changed noise characteristics may be associated with one piece of information indicating whether or not the noise characteristics greatly change, in accordance with the type of change.

With reference to the noise map information storage unit 240, the determination unit 220 determines whether or not the position of the position information m is a position at which the noise characteristic greatly changes by receiving the position information m as an input (S220).

In a case where the position is a position at which the noise characteristic greatly changes (YES in S220), the determination unit 220 determines the changed noise characteristic from the time series of the position information m. For example, the determination unit 220 determines whether a vehicle enters into a tunnel or exits the tunnel from the time series of the position information m. The determination unit 220 determines the changed noise characteristic as the noise characteristic inside the tunnel when the vehicle enters into the tunnel, and determines the changed noise characteristic as the noise characteristic outside the tunnel when the vehicle exits the tunnel.

The determination unit 220 extracts the filter coefficient corresponding to the changed noise characteristic from the filter coefficients corresponding to the position information m from the noise map information storage unit 240, and changes the filter coefficient of the adaptive filter of the suppression signal generation unit 210 to the filter coefficient corresponding to the changed noise characteristic (S220-2).

With such a configuration, it is possible to associate one or more changed noise characteristics with one position at which the noise characteristic greatly changes, in accordance with the type of change. It is possible to more flexibly apply the ANC.

### Other Modification Examples

The present invention is not limited to the above embodiments and modification examples. For example, various kinds of processing described above may be executed not only in time series in accordance with the description but also in parallel or individually in accordance with processing abilities of the devices that execute the processing or as necessary. In addition, changes can be made as needed in a range without departing from the gist of the present invention.

### Program and Recording Medium

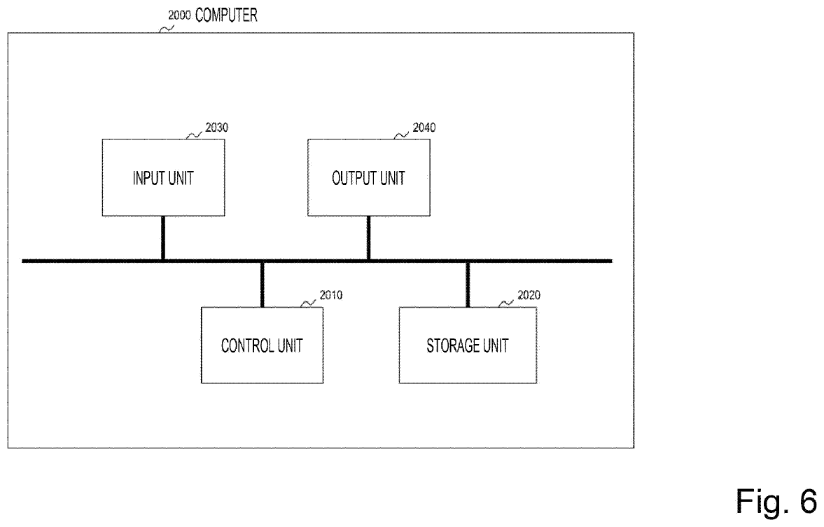

The above various kinds of processing can be implemented by loading a program for executing each step of the foregoing method to a storage unit 2020 of a computer illustrated in FIG. 6 and operating a control unit 2010, an input unit 2030, an output unit 2040, and the like.

The program in which the processing content is written may be recorded on a computer-readable recording medium. The computer-readable recording medium may be, for example, any recording medium such as a magnetic recording device, an optical disk, a magneto-optical recording medium, or a semiconductor memory.

In addition, the program is distributed by, for example, selling, transferring, or renting a portable recording medium such as a DVD or a CD-ROM on which the program is recorded. Further, a configuration may also be employed in which the program is stored in a storage device of a server computer and the program is distributed by transferring the program from the server computer to other computers via a network.

For example, a computer that executes such a program first temporarily stores a program recorded on a portable recording medium or a program transferred from the server computer in a storage device of the computer. Then, when executing processing, the computer reads the program stored in the recording medium of the computer and executes the processing according to the read program. In addition, as another mode of the program, the computer may read the program directly from the portable recording medium and execute processing according to the program, or alternatively, the computer may sequentially execute processing according to a received program every time the program is transferred from the server computer to the computer. In addition, the above-described processing may be executed by a so-called application service provider (ASP) type service that implements a processing function only by an execution instruction and result acquisition without transferring the program from the server computer to the computer. Note that the program in this mode includes information that is to be used in the process by an electronic computer, and is equivalent to the program (data and the like that are not direct commands to the computer but have properties that define the processing to be performed by the computer).

In addition, although the present devices are each configured by executing a predetermined program on a computer in the present embodiments, at least part of the processing content may be implemented by hardware.

1. A noise control apparatus that generates a cancellation signal to be reproduced by a cancelling speaker by performing an operation corresponding to position information m of a moving object in which the cancelling speaker used in active noise control is installed.

2. The noise control apparatus according to claim 1, comprising:
processing circuitry; and
a noise map information storage unit that stores information indicating whether or not a position is a position at which a noise characteristic greatly changes, wherein
in a determination processing the processing circuitry determines whether or not a position of the position information m is the position at which the noise characteristic greatly changes, with reference to the noise map information storage unit, and
in a suppression signal generation processing the processing circuitry generates the cancellation signal for suppressing noise by using a sound collection signal of a reference microphone and a model Mₐ, and updates the model Mₐ by using the sound collection signal of an error microphone, and
a different process is executed depending on whether or not the position of the position information m is the position at which the noise characteristic greatly changes.

3. The noise control apparatus according to claim 2, wherein
control is performed such that the active noise control is not performed in a case where the position of the position information m is the position at which the noise characteristic greatly changes.

4. The noise control apparatus according to claim 2, wherein
the noise map information storage unit stores the information indicating whether or not the position is the position at which the noise characteristic greatly changes and a model adapted to a changed noise characteristic at the position at which the noise characteristic greatly changes, and
in a case where the position of the position information m is the position at which the noise characteristic greatly changes, in the determination processing the processing circuitry extracts a model M_{b} adapted to the changed noise characteristic corresponding to the position of the position information m from the noise map information storage unit, and changes the model Mₐ used in the suppression signal generation processing to the model M_{b}.

5. A noise control method of generating a cancellation signal to be reproduced by a cancelling speaker by performing an operation corresponding to position information m of a moving object in which the cancelling speaker used in active noise control is installed.

6. The noise control method according to claim 5, the method, implemented by a noise control apparatus that includes processing circuitry, comprising:
assuming that information indicating whether or not a position is a position at which a noise characteristic greatly changes is stored in a noise map information storage unit;
a determination step in which the processing circuitry determines whether or not a position of the position information m is the position at which the noise characteristic greatly changes, with reference to the noise map information storage unit; and
a suppression signal generation step in which the processing circuitry generates the cancellation signal for suppressing noise by using a sound collection signal of a reference microphone and a model Mₐ, and updates the model Mₐ by using the sound collection signal of an error microphone,
wherein a different process is executed depending on whether or not the position of the position information m is the position at which the noise characteristic greatly changes.

7. A non-transitory computer-readable recording medium having recorded thereon a program for causing a computer to function as the noise control apparatus according to claim 1.
